(19) United States
(12) Patent Application Publication
(10) Pub. No.: US 2002/0125860 A1
(43) Pub. Date: Sep. 12, 2002

(54) Mains-independent power supply unit

(76) Inventors: Ernst Schworm, Muenchen (DE); Guenther Steiner, Muenchen (DE)

Correspondence Address: BELL, BOYD & LLOYD, LLC, P. O. BOX 1135, CHICAGO, IL, 60690-1135, US

(21) Appl. No.: 10/076,715

(22) Filed: Feb. 14, 2002

(30) Foreign Application Priority Data
Feb. 14, 2001 (DE) 101 06 810.7

(51) Int. Cl. H02J 7/04

(52) U.S. Cl. 320/150

(57) ABSTRACT

A mains-independent power supply unit having at least one rechargeable battery element, in particular for use in an explosion-hazard area, having peak temperatures limiting capabilities in the event of an element-internal short circuit, which includes a heat sink which is connected in a thermally conductive manner to the rechargeable battery element or to the rechargeable battery elements, and has a high thermal capacity.

### BACKGROUND OF THE INVENTION

The present invention relates to a mains-independent power supply unit having at least one rechargeable battery element particularly for use in an explosion-hazard area.

Rechargeable batteries, or secondary elements, as electrochemical elements for producing electrical power and which, after being discharged, essentially can be fully recharged again, are becoming increasingly important for supplying power to portable and, in particular, handheld electronic appliances (mobile telephones). For appliances which are switched on for a long time and have a relatively high power requirement, such as mobile telephones and cordless telephones, they represent the only practically relevant type of power supply, since primary elements (“batteries”) are in no way competitive here in terms of both financial and cost-effectiveness aspects.

With the rapidly growing and widespread use of rechargeable battery power supply units, safety aspects relating to the operation of rechargeable batteries or secondary elements are also becoming increasingly important. For example, bearing in mind that those working in explosion-hazard areas are increasingly carrying mobile telephones or cordless telephones with them, the suitability of these power supply units for use in such areas must be verified.

Very high temperatures occur in the event of an internal short circuit in rechargeable battery cells. These temperatures can damage the appliance in which the corresponding rechargeable battery is used for supplying power or, in a hazardous environment, can cause fires or explosions. The Licensing Departments for appliances which are licensed for explosion-hazard areas thus require that the peak temperatures that occur in the event of a short circuit be restricted.

In this context, it is important that the temperatures which occur in the event of a short circuit also rise as the capacity of the rechargeable battery cell rises; to a first approximation irrespective of the specific principle of operation. While in the case of older, less powerful nickel-cadmium rechargeable batteries these temperatures were still relatively non-critical, critical temperatures also occur in the case of a short circuit in modem rechargeable battery cells of the nickel-metal hydride type or lithium-ion type with a high energy density.

It is known for appropriate protection circuits to be used to provide precautions against the cells in rechargeable battery power supply units being short-circuited externally. The only measure known to date for temperature limiting in the event of an internal short circuit is, however, to restrict the energy content of the cells. This would, of course, have a major adverse effect on the useful life which can be achieved with modern cell types before charging (and, thus, on one of the critical cost-effectiveness characteristics).

The present invention is, thus, directed toward providing an improved power supply unit of this generic type, in which the peak temperatures which occur in the event of a cell-internal short circuit can be limited to values which are not critical to the appliance or the environment.

### SUMMARY OF THE INVENTION

Since virtually all the internal energy in the rechargeable battery elements is converted to heat in the event of an internal short circuit, the maximum temperature is essentially governed only by a rechargeable battery cell's own thermal capacity, assuming that the options for heat dissipation to the environment are limited (as they usually are in electronic appliances). However, this cannot be changed significantly, at least not in the electrochemically relevant part of the structure. An increase could be achieved, for example, by considerably reinforcing the casing. However, this would unacceptably increase the mass and, of course, the costs as well.

Based on these considerations, the present invention includes the fundamental idea of providing an external heat sink with a high thermal capacity. This heat sink makes good thermally conductive contact with the secondary element or the secondary elements, so that heat which is developed in the event of a short circuit can be dissipated virtually immediately to the heat sink. This reliably prevents the creation of unacceptable peak temperatures, assuming that the heat sink and the thermally conductive connection are of appropriate size.

In a first advantageous embodiment of the present invention, the heat sink has at least one solid metal part, which has a large contact area with the casing of the rechargeable battery element or of the rechargeable battery elements which is or are at risk of being short-circuited. Owing to their high thermal conductivity and thermal capacity, metal parts are particularly suitable. However, for the purposes of the present invention, it is also possible to use other materials with a high thermal capacity and high thermal conductivity; for example, elastomers and/or polymers having a high-quality metal particle filling.

In a further advantageous embodiment, a number of rechargeable battery elements are provided and are thermally conductively connected to one another such that the heat sink surrounds at least one further rechargeable battery element (preferably all the other rechargeable battery elements) in the event of an internal short circuit in one of the rechargeable battery elements. The inclusion of adjacent rechargeable battery cells which are not short-circuited in a temperature compensation assembly in the power supply makes it possible to satisfy the licensing requirements for high protection classes, in which an increasing number of faults occurring at the same time must not lead to unacceptable temperature rises.

In one particularly advantageous embodiment, the solid metal part has a large contact area with the casings of the rechargeable battery cells. By virtue of its own thermal capacity, it may itself be used as a part of the heat sink and, at the same time, represents a highly effective thermally conductive connection between the rechargeable battery cells, which each have their own respective thermal capacities.

When using (by far the most widely used) rechargeable battery cells or secondary elements with a basic cylindrical shape (monocells, baby cells and mignon cells), each metal part also has at least one contact surface which is in the form of a cylindrical section and abuts against the outer surface of the rechargeable battery elements which are being used. The width of this contact area advantageously corresponds essentially to the length of the rechargeable battery elements, in order to maximize the thermal contact area. It is self-evident that rechargeable batteries with a different basic shape, for example a cuboid shape, likewise can be combined with a metal part, or metal parts, matched to that external shape.

In principle, in the specific embodiment in which the part is used as a heat sink and/or thermally conductive element, it is desirable for the contact area of the external wall of the rechargeable battery element or of the rechargeable battery elements to be as large as possible. In the case of cylindrical rechargeable battery elements, this is taken into account, in addition to the metal part having as great a width as possible, by a looping angle which is as large as possible. However, the specific design embodiment must take account of additional requirements, in particular with regard to the physical size and external shape of the power supply unit, and the production costs.

Depending on the number of rechargeable battery elements which are intended to be thermally conductively connected to one another, and their physical position in the power supply unit, looping angles in the range between 30° and 120° may be expedient. Furthermore, a compact, solid version of the metal part or of the metal parts, in particular as a low-cost extruded profile, may be expedient while, in other designs, a version in the form of a relatively flat part, which is provided with the cylindrical sections by forming, is expedient. Particularly in the latter case, a bracket-like configuration of the metal part may at the same time offer the capability to fix the rechargeable battery cells relative to one another.

The use of copper or aluminum as a material for the metal part is preferable, both with regard to the thermal characteristics and with regard to production and cost aspects.

Additional features and advantages of the present invention are described in, and will be apparent from, the following Detailed Description of the Invention and the Figures.

### BRIEF DESCRIPTION OF THE FIGURES

FIG. 1 shows, as a first embodiment of the present invention, a power supply unit having a pair of rechargeable battery elements in the form of mignon cells, and two bracket-like metal parts.

FIG. 2 shows, as a second exemplary embodiment of the present invention, a group of four rechargeable batteries in the form of mignon cells, with one metal part.

FIG. 3 shows, as a third embodiment of the present invention, a group of four rechargeable batteries in the form of mignon cells, combined with six metal parts in the form of extruded profiles.

FIG. 4 shows, as a fourth embodiment of the present invention, a cuboid rechargeable battery element, combined with an L-shaped metal part as a heat sink.

FIG. 5 shows, as a fifth embodiment, a group of four rechargeable batteries in the form of mignon cells, combined with a central metal part in the form of an extruded profile.

FIG. 6 shows, as a sixth embodiment, a group of two mignon cell rechargeable batteries, with a metallic sheath as a heat sink.

FIG. 7 shows, as a seventh embodiment, a pair of flat cuboid rechargeable battery cells with a rectangular metal plate as a heat conductor and sink.

FIG. 8 shows, as an eighth embodiment, a pair of flat cuboid rechargeable battery cells with a U-shaped metal profile as a heat conductor and sink.

### DETAILED DESCRIPTION OF THE INVENTION

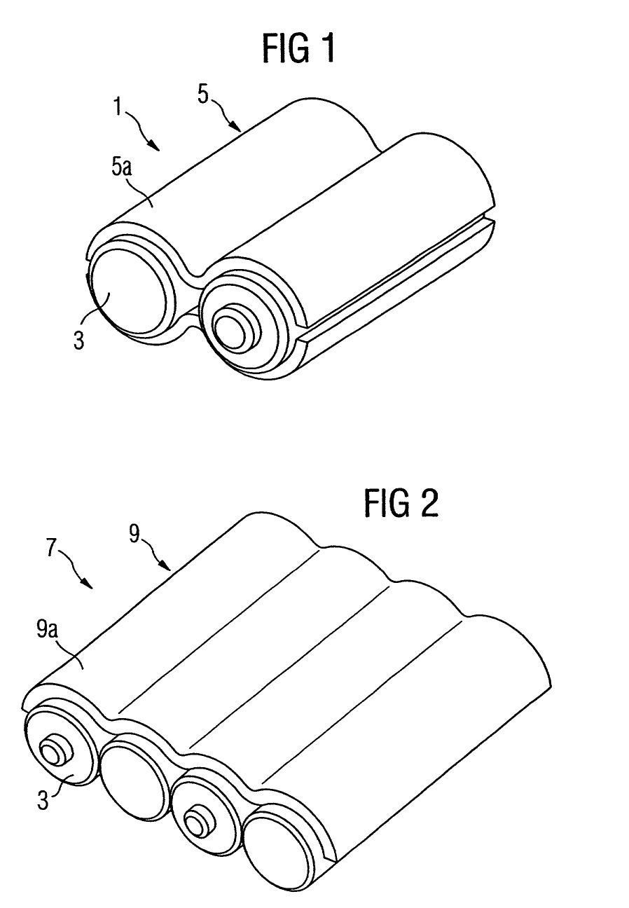

FIG. 1 shows a rechargeable battery block 1 having two mignon cell rechargeable batteries 3, which are inserted between two identically shaped, bracketlike metal parts 5. In the event of an element-internal short circuit in one of the rechargeable batteries, the metal parts 5 and the respective other rechargeable battery, which is not short-circuited, form a heat sink in order to limit the peak temperature that occurs in the rechargeable battery block 1 as a result of the short circuit.

As can be seen from FIG. 1, the metal parts 5 each have two cylindrical wall sections 5a, which are matched to the basic cylindrical shape of the mignon cell rechargeable batteries 3 and rest against the rechargeable battery wall, enclosing it over an angle of about 150°, and having a width which corresponds virtually to the length of the rechargeable batteries. This results in a large thermal contact area. The wall thickness of the metal parts 5 is between 1 mm and a few millimeters and provides a sufficiently large volume to ensure a thermal capacity which reliably prevents the maximum permissible peak temperature from being exceeded in the event of a short circuit.

The rechargeable battery block 7 shown in FIG. 2 operates in an analogous manner, being formed from four mignon cell rechargeable batteries 3 and a metal part 9, which covers them like a shroud and has four cylindrical wall sections 9a. In this case as well, the width of the metal part 9 corresponds essentially to the length of the rechargeable batteries 3 but, owing to the denser packing of the rechargeable batteries, the looping angle is considerably less. The thermal capacity provided by the metal part 9 for each rechargeable battery is also less; however, this is more than compensated for by the combination of all the rechargeable batteries to form a cohesive heat sink, whose thermal capacity is adequate overall. The arrangement shown in FIG. 2 has a peak temperature which remains in the permissible range even in the event of a simultaneous short circuit of two rechargeable batteries.

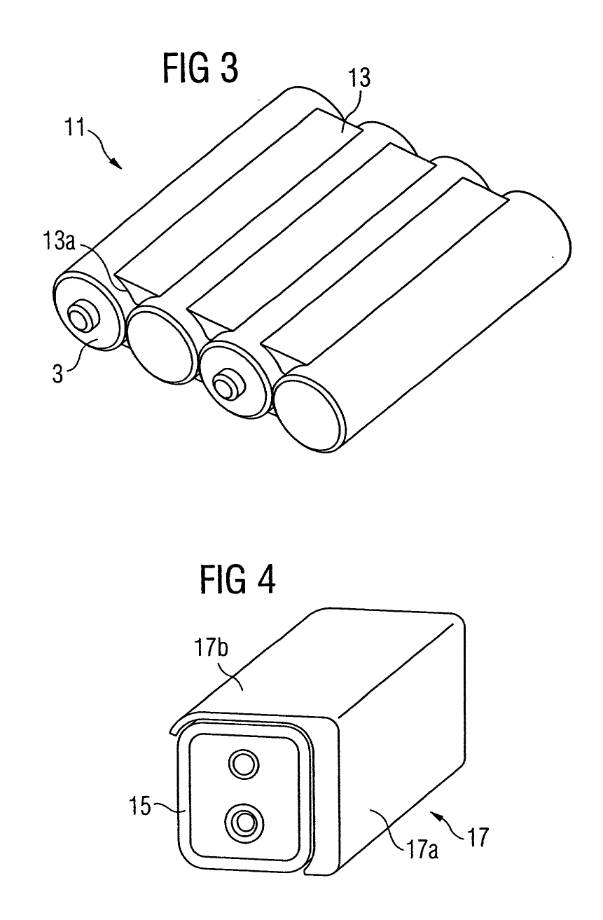

As a further exemplary embodiment, FIG. 3 shows a rechargeable battery block 11 with four mignon cell rechargeable batteries 3 and six metal parts 13, which are inserted between them and are produced as an extruded profile. These metal parts have an essentially triangular cross section, with two sides of the “triangle” in fact being formed by circular arcs which are matched to the cross section of the mignon cell rechargeable batteries 3. The metal parts 13 thus also have cylindrical wall sections 13a, like the metal parts in the above-mentioned embodiments. These can be manufactured at a particularly low cost, although the formation of the rechargeable battery block 13 involves a somewhat greater assembly cost than in the case of the first and second embodiments.

FIG. 4 shows a single rechargeable battery 15 with a cuboid shape, as is known, by way of example, as a 9 V block, with an L-shaped metal part 17 as a heat sink. The metal part 17 has a first, thicker limb 17a and a second, thinner limb 17b, which engages in an elastically sprung manner around the rechargeable battery 15 like a bracket and, thus, presses the metal part 17 against it in order to achieve good thermal transmission. The relatively large-volume thicker limb 17a provides the volume of metal required to effectively limit the peak temperature in the event of a short circuit in the relatively high-energy rechargeable battery 15.

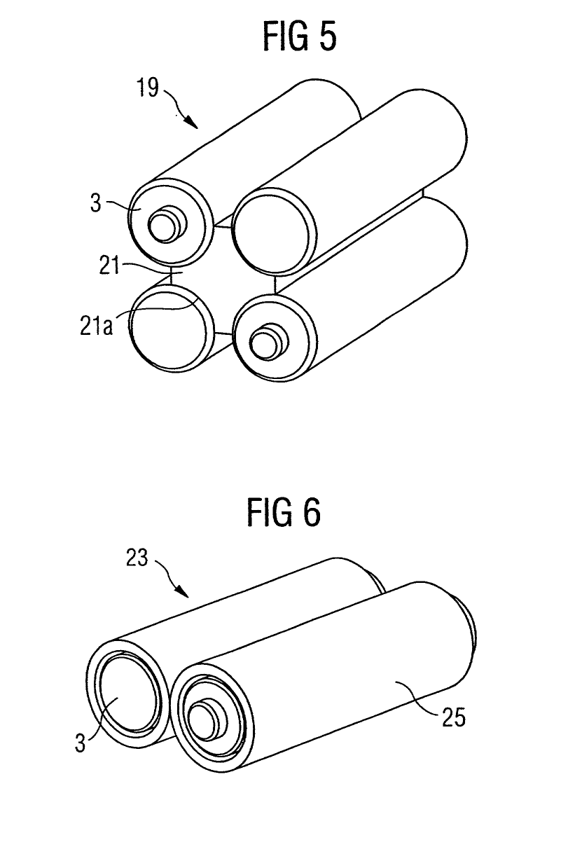

Finally, FIG. 5 once again shows a rechargeable battery block 19, which is in the form of a pack of four rechargeable batteries and has four mignon cell rechargeable batteries 3 and one metal part 21. In this case, the rechargeable batteries 3 are arranged at the corners of a square and the metal part 21 which, to a first approximation, has a cruciform shape, is located between them. This metal part 21 has four cylindrical wall sections 21 a, which touch the wall of the respectively adjacent rechargeable battery over an angle of 90°. The method of operation corresponds essentially to that of the arrangements shown in FIG. 2 or 3. However, in this case, the connection in particular advantageously involves low production costs for the extruded metal part 21, and a low assembly cost.

FIG. 6 shows a rechargeable battery block 23 having two mignon cell rechargeable batteries 3 and one metal part 25, which completely sheaths both of them and whose cross section is in the form of a figure “eight”, which also has two hollow-cylindrical parts 25a, 25b. The method of operation corresponds to that of the arrangement shown in FIG. 1, but the contact area between the rechargeable batteries and the metal part is even larger than that in FIG. 1.

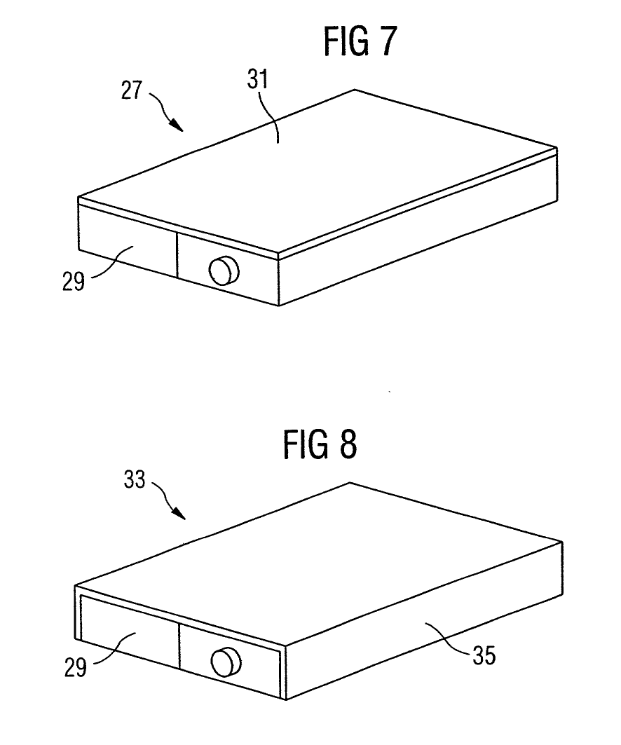

FIG. 7 shows a rechargeable battery block 27 having a pair of flat cuboid rechargeable batteries 29, which are jointly covered by a rectangular metal plate 31. Like the metal part in each of the above-mentioned embodiments, this metal plate itself acts as a heat sink by virtue of its own thermal capacity and, on the other hand, it is used to conduct heat to the second rechargeable battery in the event of a short circuit in one of the rechargeable batteries.

Finally, FIG. 8 shows a further rechargeable battery block 33 which, in addition to the flat cuboid rechargeable batteries 29 shown in FIG. 7, has a metal U-profile (copper or aluminum) which engages around them jointly, as a heat conductor and sink.

Although the present invention has been described with reference to specific embodiments, those of skill in the art will recognize that changes may be made thereto without departing from the spirit and scope of the invention as set forth in the hereafter appended claims.

1. A mains-independent power supply unit, comprising:
at least one rechargeable battery element; and
a heat sink for peak temperature limiting in the event of an element-internal short circuit, the heat sink connected in a thermally conductive manner to the rechargeable battery element and having a high thermal capacity.

2. A mains-independent power supply unit as claimed in claim 1, wherein the heat sink includes at least one solid metal part having a large contact area for contact with a casing of the at least one rechargeable battery element.

3. A mains-independent power supply unit as claimed in claim 2, wherein the power supply unit includes a plurality of rechargeable battery elements thermally conductively connected to one another such that the heat sink includes at least one further rechargeable battery element when there is an element-internal short circuit in one rechargeable battery element.

4. A mains-independent power supply unit as claimed in claim 2, wherein the large contact area contacts with the casings of at least two rechargeable battery elements.

5. A mains-independent power supply unit as claimed in claim 2, wherein the at least one rechargeable battery element has a cylindrical external shape, and the at least one solid metal part has at least one contact surface formed as a cylindrical section having a width which is substantially the same as a length of the cylindrical rechargeable battery element.

6. A mains-independent power supply unit as claimed in claim 3, wherein the at least one solid metal part has at least two contact surfaces formed as cylindrical sections via which the at least one cylindrical metal part touches the respectively associated rechargeable battery element.

7. A mains-independent power supply unit as claimed in claim 6, wherein the power supply unit includes four cylindrical rechargeable battery elements and one solid metal part having four contact surfaces formed as cylindrical sections which respectively touch the four cylindrical rechargeable battery elements over a looping angle of not less than 60°.

8. A mains-independent power supply unit as claimed in claim 6, wherein the power supply unit includes two cylindrical rechargeable battery elements and two solid metal parts, each of the solid metal parts having two contact surfaces formed as cylindrical sections which respectively touch the two cylindrical rechargeable battery elements over a looping angle of not less than 120°.

9. A mains-independent power supply unit as claimed in claim 5, wherein the rechargeable battery elements are mignon cells.

10. A mains-independent power supply unit as claimed in claim 2, wherein the power supply unit includes n rechargeable battery elements and at least n−1 solid metal parts respectively inserted between two of the rechargeable battery elements.

11. A mains-independent power supply unit as claimed in claim 10, wherein the rechargeable battery elements have a cylindrical external shape and 2×(n−1) solid metal parts, each of the solid metal parts being insert ed between two rechargeable battery elements and touching the rechargeable battery elements over a looping angle in a range between 30° and 90°.

12. A mains-independent power supply unit as claimed in claim 2, wherein the at least one solid metal part has an extruded profile.

13. A mains-independent power supply unit as claimed in claim 6, wherein the at least one solid metal part has a substantially constant thickness of at least 1 nm.

14. A mains-independent power supply unit as claimed in claim 6, wherein each of the at least one solid metal parts respectively brackets the rechargeable battery elements to which the solid metal part is thermally conductively connected, resulting in the rechargeable battery elements being fixed in position relative to one another.

15. A mains-independent power supply unit as claimed in claim 2, wherein the at least one rechargeable battery element has a substantially cuboid shape, and the at least one solid metal part has at least one planer contact surface formed as one of a flat plate, an L-profile, and a U-profile.

16. A mains-independent power supply unit as claimed in claim 2, wherein the at least one solid metal part is formed from one of copper, aluminum, plastic with a high-quality copper particle filling, and plastic with a high-quality aluminum particle filling.
